(19) United States
(12) Patent Application Publication
(10) Pub. No.: US 2004/0253380 A1
(43) Pub. Date: Dec. 16, 2004

(54) Substrate processing system, coating apparatus, and coating method

(75) Inventor: Shuho Motomura, Kumamoto (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/820,752

(22) Filed: Apr. 9, 2004

(30) Foreign Application Priority Data
Apr. 10, 2003 (JP) P2003-106562
Mar. 12, 2004 (JP) P2004-071234

(51) Int. Cl. B05D 3/02

(52) U.S. Cl. 427/356; 427/421.1

(57) ABSTRACT

A coating apparatus 1a for forming a coating film on a coated surface by raising a coating liquid that is reserved under a substrate 10 by a capillary phenomenon of a substrate processing means 2, bringing the raised coating liquid into contact with the coated surface of the substrate 10 that is directed downward, and then moving relatively the substrate processing means 2 and the substrate 10, comprises a holding means 5a for holding detachably the substrate 10, a chucking means 3 for chucking the substrate 10 from the holding means 5a in a state that the processes surface of the substrate 10 is directed downward, and a moving means 4 for moving relatively the substrate processing means 2 and/or the chucking means 3 in a horizontal plane.

### BACKGROUND OF THE INVENTION

1. Field of the Invention

The present invention relates to a substrate processing system for processing a substrate in a state that a processed surface of the substrate is directed downward and, more particularly, a coating apparatus and a coating method for coating a liquid such as photoresist, or the like in a state that a coated surface of the substrate is directed downward.

2. Description of the Related Art

Conventionally a spin coater is normally used as the coating apparatus (coater) for coating a coating liquid such as photoresist, or the like on a substrate such as a silicon wafer, or the like. Such spin coater forms a coating film on a substrate surface by dropping the coating liquid onto a center of the substrate, and then revolving the substrate at a high speed to spread the coating liquid by an action of a centrifugal force.

By the way, according to the spin coater, sometimes a swelling portion called a fringe is formed on a peripheral portion of the substrate. In particular, in a liquid crystal display device or a photo mask used to manufacture the liquid crystal display device, the resist must be coated on a large-sized substrate (for example, a square substrate having at least one side of 300 mm or more). In addition, concerning the higher precision of the pattern and the larger size of the substrate being required in recent years, development of the technology of coating a uniform resist film on the large-sized substrate has been desired.

As the technology of coating the uniform resist film on the large-sized substrate, the technology of the CAP coater is proposed such as disclosed in JP-A-2001-62370.

This CAP coater forms a coating film by sinking a nozzle having a capillary clearance therein in a liquid tank in which the coating liquid is reserved, then lifting the nozzle in vicinity of a coated surface of the substrate, which is held by a vacuum chucking board in such an attitude that the coated surface is directed downward, and bringing the coating liquid into contact with the coated surface from the capillary clearance, and then scanning the nozzle on the overall coated surface.

More specifically, the nozzle that is sunk completely in the resist in the liquid tank, in which the resist is filled to a predetermined height, is lifted to the lower side of the coated substrate. Then, the control section causes the liquid tank to stop once the lifting, and then causes only the nozzle to project from the liquid tank.

Here, since the nozzle is sunk completely in the resist, the capillary clearance is filled with the resist. That is, the nozzle is lifted in a state that the resist is filled in the capillary clearance up to its top end.

Then, the control section stops the lifting of the nozzle only, and then lifts the liquid tank once again to bring the resist into contact with a coated surface of a photo mask blank. That is, the control section brings the resist filled in the capillary clearance of the nozzle into contact with the coated surface.

In this manner, the resist film is formed by bringing down the nozzle as well as the liquid tank up to a coating height position while bringing the resist into contact with the coated surface of the photo mask blank, and then moving the photo mask blank to scan the overall coated surface with the nozzle.

According to this system, the resist film having a uniform film thickness can be coated without forming the fringe on the peripheral portion of the substrate.

Also, this CAP coater has a turning mechanism to turn the vacuum chucking plate up to the vertical direction. Therefore, when the substrate is to be set, the vacuum chucking plate is turned until the vacuum chucking surface is directed upward and then the substrate is loaded on the vacuum chucking surface to direct the coated surface upward. Then, when setting of the substrate is finished, the vacuum chucking plate is turned until the vacuum chucking surface is directed downward once again, and then the coating is carried out. As a result, the advantage of this coater resides at the setting of the substrate being readily executed.

However, although this CAP coater has such an advantage as described above, the vacuum chucking plate is likely to be moved slightly during the coating due to backlash in the turning mechanism, for instance, so that in some cases a horizontal balance might be changed. As a consequence, there existed the problem that such variation in the horizontal balance has an adverse influence to the quality of the thin film (e.g., uniformity in film thickness).

### SUMMARY OF THE INVENTION

Therefore, the present invention has been achieved in view of the above problem, and it is an object of the present invention to provide a substrate processing system, a coating apparatus, and a coating method, capable of chucking a substrate by a chucking plate to direct a processed surface of the substrate downward without a turning mechanism.

As described above, according to the present invention, since a holding means for holding detachably a substrate, a chucking means for chucking the substrate from the holding means in a state that a processes surface of the substrate is directed downward, and a moving means for moving a substrate processing means and/or the chucking means in a horizontal plane are provided, a positional precision between the coated surface and a nozzle, especially a positional precision in the vertical direction having a strong influence on quality of a film thickness, can be enhanced and thus a film thickness can be made uniformly much more.

The inventors of the present invention found it out that the problem in precision caused due to a backlash in the turning mechanism might bring about the adverse effect on the quality of the film thickness, from which the present invention has been accomplished to provide a substrate processing system, a coating apparatus, and a coating method thereof without producing such an adverse effect on the quality of the film thickness and without lowering productivity thereof.

In order to achieve the above object, a substrate processing system of the present invention is constructed to comprise a holding means for holding detachably a substrate; a chucking means for chucking the substrate from the holding means in a state that a processes surface of the substrate is directed downward; a processing means provided under the substrate, for processing the processes surface of the substrate; and a moving means for moving the processing means and/or the chucking means in a horizontal plane.

In this manner, when the substrate is chucked in a state that the processes surface of the substrate is directed downward, the turning mechanism in the prior art can be neglected. Thus, a positional precision between the processes surface of the substrate and the processing means becomes high, and process quality due to the positional precision can be also improved.

In this case, the term “horizontal plane” mentioned herein includes a plane with a certain inclination in as much as any problem does not happen to the substrate being processed from the lower side.

Also, in order to chuck the substrate from holding means in a state that the processes surface of the substrate is directed downward, the holding means holds the substrate in such a manner that the processes surface of the substrate is directed downward and the chucked surface of the substrate is directed upward. At that time, preferably the holding means for holding only the outer peripheral portion of the processes surface of the substrate should be provided. As a result, such a disadvantage can be avoided that the important portion of the substrate is damaged.

In addition, preferably the substrate should be chucked by the chucking means by causing the chucked surface of the substrate held by the holding means and the chucking surface of the chucking means to come close to each other. When doing this, such a disadvantage can also be avoided that the important portion of the substrate is damaged.

In order to achieve the above object, a coating apparatus of the present invention for forming a coating film on a coated surface by raising a coating liquid that is reserved under a substrate by a capillary phenomenon of a nozzle, bringing the raised coating liquid into contact with the coated surface of the substrate that is directed downward, and then moving the nozzle and the substrate, is constructed to comprise a holding means for holding detachably the substrate; a chucking means for chucking the substrate from the holding means in a state that the processes surface of the substrate is directed downward; and a moving means for moving relatively the nozzle and/or the chucking means in a horizontal plane.

With this arrangement, a positional precision between the coated surface and the nozzle can be enhanced and also a film thickness can be made uniformly.

Also, preferably the holding means is constructed to lever the substrate in the vertical direction by turning the substrate by a predetermined angle upon attaching and detaching the substrate. In this case, the substrate can be attached and detached easily without fail rather than the case of the substrate being aligned in the horizontal direction, whereby the workability can be improved. In particular, this coating apparatus is available to the attaching/detaching of a large-sized substrate (at least the square substrate having one side of 300 mm or more, etc.).

Also, this coating apparatus is applied preferably to the case that the substrate is a photo mask blank and the coating film is made of resist. When doing this, the substrate of high quality can be mass-produced effectively.

Here, preferably the coating apparatus should be constructed to include a measuring means for measuring a distance from any origin position provided below the coated surface of the substrate to the coated surface of the substrate, a lifting means for lifting the nozzle, and a controlling means for controlling the lifting means based on a measured result of the measuring means.

In this way, when the distance from any origin position (e.g., an origin position of the measuring means) set below the coated surface of the substrate to the coated surface of the substrate is measured, a plate thickness of the substrate can be calculated based on this distance and also a clearance between the coated surface and the nozzle can be controlled based on the calculated plate thickness. Therefore, not only a human measuring miss and an inputting miss can be prevented but also the disadvantages such that the nozzle comes in touch with the substrate and the substrate is subjected to the damage, etc. can be prevented without fail. Also, unless the plate thickness is calculated, the lifting means can be controlled directly based on the distance from the origin position to the coated surface of the substrate.

In order to achieve the above object, a coating method of the present invention of forming a coating film on a coated surface by raising a coating liquid by a capillary phenomenon of a nozzle, bringing the raised coating liquid into contact with the coated surface of the substrate that is directed downward, and then moving relatively the nozzle and the substrate, comprises a step of setting the substrate on a holding means such that the processes surface of the substrate is directed downward; a step of moving relatively vertically the holding means and/or a chucking means to come close to each other in a state that the processes surface of the substrate is directed downward; a step of chucking the substrate by the chucking means; a step of moving relatively vertically the holding means and/or the chucking means to separate from each other; and a step of forming the coating film on the coated surface of the substrate by moving relatively the nozzle and/or the chucking means in a horizontal plane. Also, this coating method should be implemented preferably in the case that the substrate is the photo mask blank and the coating film is made of the resist. When doing this, the substrate of high quality can be mass-produced effectively.

By doing this, even though the coating film is formed on the coating surface in a state that the coating surface of the substrate is directed downward, there is no need to invert the substrate. Therefore, a coating operation can be simplified, a positional precision between the vacuum chucking board and the nozzle can be enhanced, and a film thickness can be uniformized further more.

### BRIEF DESCRIPTION OF THE DRAWINGS

FIG. 1 shows a schematic side view of a substrate processing system according to the present invention.

FIG. 2 shows a schematic front view of the substrate processing system according to the present invention.

FIG. 3 shows a schematic side view of a coating apparatus according to the present invention.

FIG. 4 shows a schematic front view of the coating apparatus according to the present invention.

FIG. 5 shows a schematic enlarged sectional view of a pertinent section of a coating means in the coating apparatus according to the present invention.

FIG. 6 shows a schematic block diagram of a controlling means in the coating apparatus according to the present invention.

FIG. 7 shows a schematic enlarged sectional view of a pertinent section in the coating apparatus according to the present invention to explain positional relationships to the substrate.

FIGS. 8(a) to 8(c) shows a schematic view explaining operations of the coating apparatus, wherein FIG. 8(a) shows a side view to measure a distance, FIG. 8(b) shows a side view to adjust a height of a liquid tank, and FIG. 8(c) shows a side view to bring the liquid into contact with the substrate.

FIG. 9 shows a schematic flowchart of a coating method according to the present invention.

### DESCRIPTION OF THE PREFERRED EMBODIMENTS

Respective embodiments of the present invention will be explained with reference to the drawings hereinafter.

[Substrate Processing System]

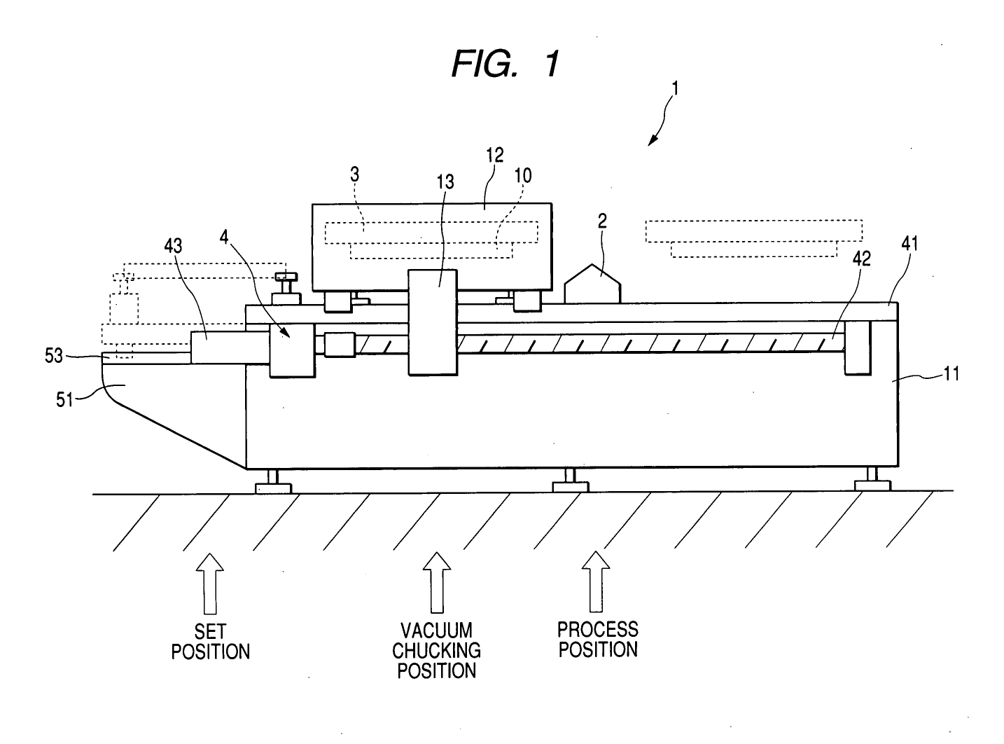

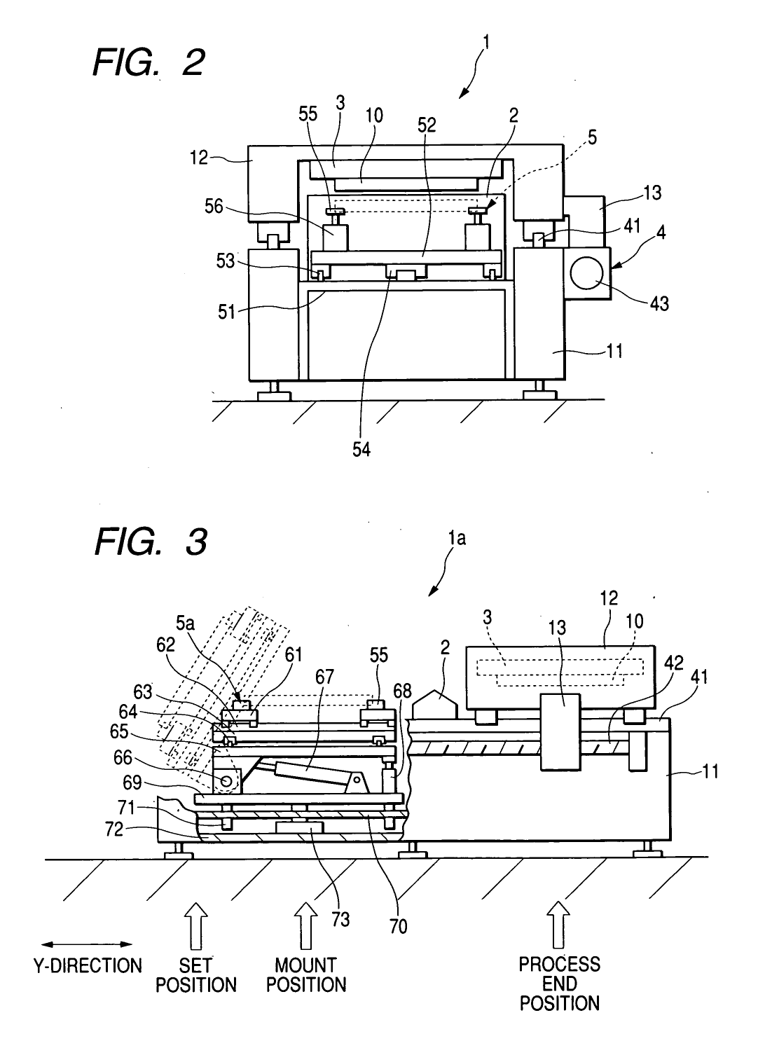

First, an embodiment of a substrate processing system of the present invention will be explained with reference to FIG. 1 and FIG. 2 hereunder.

FIG. 1 is a schematic side view of a substrate processing system according to the present invention, and FIG. 2 is a schematic front view of the same.

As shown in FIG. 1, a substrate processing system 1 includes a substrate processing means 2 provided to a base frame 11, a chucking means 3 provided to a movable frame 12, a moving means 4 for moving the movable frame 12 on the base frame 11 in the horizontal direction, a holding means 5 for holding detachably a substrate 10, and a control section (not shown).

The substrate processing means 2 applies the processing to the substrate 10 whose coated surface is directed downward. This substrate processing means 2 is provided to an almost center portion of the rectangular-box like base frame 11.

As the contents of the process, for example, there is the process of coating a coating liquid to form a resist film used in the photolithography step when the substrate 10 is the photo mask blank used to manufacture the photo mask. In contrast, there is the process of coating a coating liquid used to form the resist film, the protection film, or the like, from the lower side of the substrate 10 when the substrate 10 is the glass substrate or the device substrate of the liquid crystal display device. However, the process is not particularly limited to these processes. Any process may be carried out if such process is applied to the coated surface of the substrate 10 that is directed downward.

Since a pair of opposing side plates and a top plate for coupling the side plates are formed integrally, the movable frame 12 has an enough mechanical strength not to lose a positional precision between the substrate 10 and the substrate processing means 2 due to a lack of the rigidity.

Also, the movable frame 12 is coupled to the base frame 11 movably in the horizontal direction via linear ways 41.

In addition, the chucking means 3 composed of a vacuum chucking plate in which a plurality of vacuum chucking holes (not shown) are formed to pass therethrough is fitted to an almost center portion of the top plate of the movable frame 12. Also, a movable portion 13 in which the nuts in which a ball screw 42 described later is screwed are formed is provided to one side plate of the movable frame 12 to project.

The moving means 4 is composed of the linear ways 41 for moving the movable frame 12 while causing a side plate to guide, the ball screw 42 that is screwed into the nut of the movable portion 13, and a motor 43 for rotating the ball screw 42.

When the motor 43 is activated according to the instruction issued from the control section, the ball screw 42 is rotated. Thus, the movable portion 13 can be horizontally moved by a predetermined distance in the direction that responds to the rotating direction of the ball screw 42.

Here, a positional precision between the chucking means 3 and the substrate processing means 2 in the vertical direction is decided based on an error between the chucking means 3 and the linear ways 41, an error between the linear ways 41 and the substrate processing means 2, and an error of the linear ways 41. In other words, since a turning mechanism (inverting means) for directing the processed surface of the substrate 10 downward is not provided to the movable frame 12, the error caused due to the clearance of the rotation axis of the inverting means can be eliminated, and therefore the positional precision can be improved.

The holding means 5 is composed of a holding means frame 51 formed integrally with the base frame 11, linear ways 53 provided on the holding means frame 51, a base plate 52 guided by the linear ways 53 to move on the holding means frame 51, a linear motor 54 for causing the base plate 52 to move in the horizontal direction, and air cylinders 56 (or electromagnetic solenoids) to a rod top end of each of which a holding member 55 is provided.

In this case, the air cylinders 56 are fitted detachably at any position of base plate 52 by screws, or the like so as to conform to a substrate size.

At this time, it is preferable that a fixed position of the air cylinder 56 should be marked every size of the substrate 10. When doing this, fitting positions of the air cylinders 56 can be changed in a short time in response to the processed substrate 10.

Each of the holding members 55 consists of a loading surface for loading a peripheral portion of the substrate 10 thereon, and an engaging level difference for positioning the substrate 10. With respect to the square substrate 10, the holding member 55 is provided to four corners of the base plate 52 respectively to hold four corners of the substrate 10. In this case, providing positions of the holding members 55 can be changed appropriately in light of the shape of the substrate, the positional precision of the substrate, etc., and such positions are not always limited to the case that their four corners are held.

Next, an operation of the substrate processing system 1 constructed as above will be explained with reference to FIG. 1 hereunder.

The substrate processing system 1 is in its initial state when the base plate 52 is positioned at a set position of the substrate, the movable frame 12 is positioned at a vacuum chucking position, and rods of four air cylinders 56 on the base plate 52 are put down.

Then, the operator or the robot loads the substrate 10 on the loading surfaces of the holding members 55 to direct the processed surface downward. Here, since the engaging level difference is provided to each holding member 55, the substrate 10 can be easily positioned. Also, when the base plate 52 is moved from the set position to the vacuum chucking position to stop there, the holding members 55 can stop the substrate 10. In this case, if this engaging level difference is shaped not to exceed the chucked surface of the substrate, the chucking means can contact or come close to the chucked surface of the substrate.

When the substrate 10 is loaded on the holding members 55 in this manner, the system is operated subsequently according to the instruction issued from the control section as follows. First, the baseplate 52 is moved to the vacuum chucking position by the linear motor 54.

When the holding means 5 is positioned at the vacuum chucking position, the rods of four air cylinders 56 are simultaneously raised and thus the substrate 10 comes into contact with the chucking means 3 or comes close to the chucking means 3. Then, the substrate 10 is chucked by the chucking means 3 because of a chucking action of the chucking means 3. Then, when the air cylinders 56 put down the rods, the movable frame 12 is moved toward a process position.

The substrate processing means 2 applies the substrate processing to the processed surface of the downward-directed substrate 10 from the lower side during when the movable frame 12 passes through the process position. At this time, since the inverting means that lowers the positional precision between the chucking means 3 and the substrate processing means 2 in the vertical direction is not provided to the movable frame 12, the error caused due to the clearance of the rotation axis of the inverting means can be eliminated, and therefore the positional precision can be improved.

Then, the movable frame 12 is returned from the process position to the vacuum chucking position by actuating reversely the motor 43 (ball screw 43). Then, the rods of the air cylinders 56 are lifted to bring the substrate 10 into contact with the loading surfaces of the holding members 55. Thus, the substrate 10 is positioned by the engaging level difference.

Then, the chucking action of the chucking means 3 is stopped, and then the rods of four air cylinders 56 are put down simultaneously to load the processed substrate 10 on the holding means 5.

Then, the base plate 52 is moved from the vacuum chucking position to the set position by the linear motor 54. Then, the operator or the robot takes out the processed substrate 10 from the holding means 5.

In this manner, according to the substrate processing system 1 of the present embodiment, even though the substrate processing means 2 processes the substrate 10 from the lower side while moving the substrate 10 to direct downward the processed surface, the positional precision between the processed surface of the substrate 10 chucked by the chucking means 3 and the substrate processing means 2 in the vertical direction can be improved.

In this case, in the present embodiment, the holding means 5 is moved horizontally to the vacuum chucking position. But the movable frame 12 (chucking means 3) may be moved to the set position, otherwise both means may be moved. Also, the movable frame 12 (chucking means 3) is constructed to move horizontally toward the process position. But the present embodiment is not limited to this configuration. For example, the movable frame 12 is not moved but the substrate processing means 2 may be moved in the horizontal direction. In addition, both the movable frame 12 and the substrate processing means 2 may be moved.

Further, a plurality of holding members 55 are put up and down by using a plurality of air cylinders 56. But the present embodiment is not limited to this configuration. For example, a motor-driven lifting means for lifting and falling the holding means frame 51 may be provided in place of the holding members 55.

[Coating Apparatus]

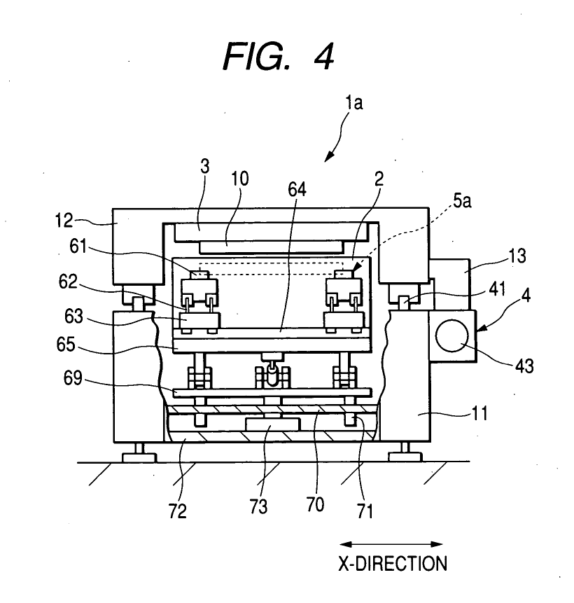

Next, an embodiment of a coating apparatus of the present invention will be explained with reference to FIG. 3 and FIG. 4 hereunder.

FIG. 3 is a schematic side view of a coating apparatus according to the present invention, and FIG. 4 is a schematic front view of the same.

As shown in FIG. 3, a coating apparatus la includes the substrate processing means 2 provided to the base frame 11, the chucking means 3 provided to the movable frame 12, the moving means 4 for moving the movable frame 12 in a horizontal plane, and a holding means 5a for holding the substrate 10 detachably and mounting it on the chucking means 3.

That is, the coating apparatus 1a of the present embodiment is constructed such that the substrate processing means 2 of the substrate processing system 1 is employed as the coating means and the holding means 5a is provided instead of the holding means 5.

The coating means 2 as the substrate processing means 2 is provided to an almost center portion of the rectangular-box like base frame 11. This coating means 2 is constructed to have the linear gauge 9 of the CAP coater in the prior art.

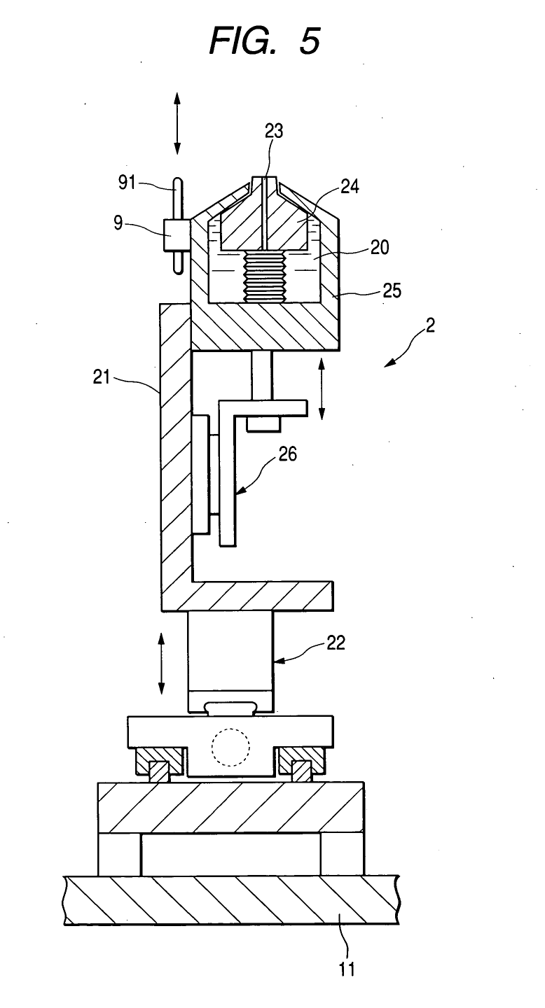

More concretely, as shown in FIG. 5, the coating means has a motor-driven lifting portion 22 for lifting a supporting plate 21, a nozzle 24 having a capillary clearance 23, a liquid tank 25 fixed to an upper end portion of the supporting plate 21 to contain the nozzle 24 therein in a state that such nozzle 24 is dipped in a coating liquid 20, and an air-cylinder driven nozzle lifting portion 26 for projecting the nozzle 24 from the liquid tank 25 up to a predetermined height. In addition, as a measuring means for measuring a plate thickness of the substrate 10, a linear gauge 9 is provided to a side portion of the liquid tank 25.

The lifting portion 22 has a lifting mechanism that can adjust finely a height of the supporting plate 21 by a motor (not shown) controlled by a controlling means 8. In other words, the lifting portion 22 serves as a lifting means for lifting the nozzle 24 while controlling a clearance between the nozzle 24 and the coated surface of the substrate 10.

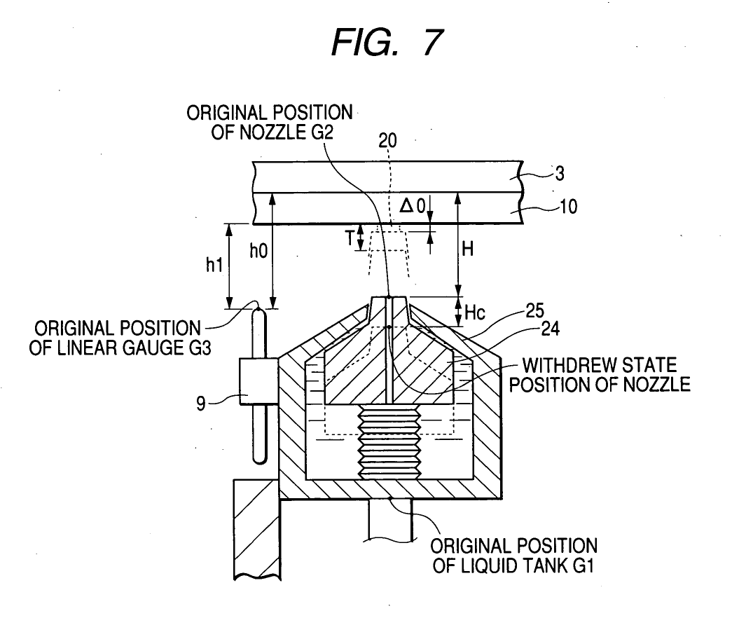

Also, the nozzle lifting portion 26 has a lifting mechanism that lifts the nozzle 24 by an air cylinder (not shown) controlled by the controlling means 8 only by a predetermined distance Hc (see FIG. 7) to project its top end portion from the liquid tank 25.

Here, the liquid tank 25 is fixed to an upper portion of the supporting plate 21, and a linear gauge 9 is fixed to a side surface of the liquid tank 25. In addition, the nozzle 24 is lifted by the nozzle lifting portion 26 only by the predetermined distance Hc (see FIG. 7). with respect to the liquid tank 25. Accordingly, when the lifting portion 22 controls a height of the supporting plate 21, respective heights of the linear gauge 9, the liquid tank 25, and the nozzle 24 in its projected state are controlled at the same time.

The linear gauge 9 as a measuring means is fixed to a side surface of the liquid tank 25 on the vacuum chucking position side.

When this linear gauge 9 receives a measuring start signal from the controlling means 8, a measuring contact 91 is lifted automatically to measure a position at which such contact 91 comes into contact with the substrate 10 (a distance h1 (see FIG. 7) from an origin position G3 of the linear gauge to the coated surface of the substrate 10). Then, the measured result is output to the controlling means 8.

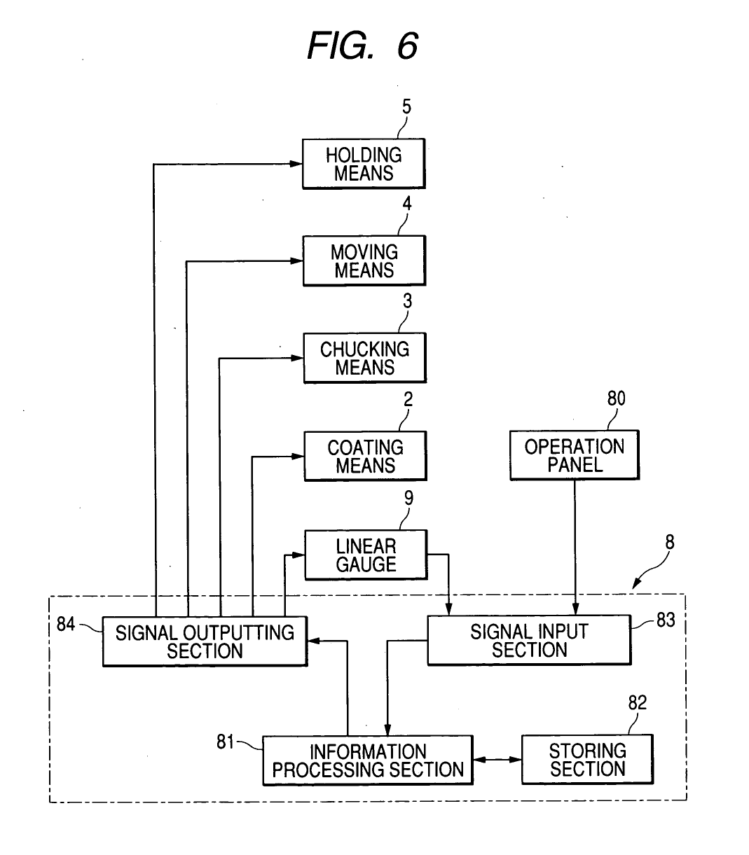

As shown in FIG. 6, the controlling means 8 is composed of an information processing section 81 formed of CPU, a storing section 82 for storing the information, a signal inputting section 83 having an analog-digital converting function, and a signal outputting section 84 having a digital-analog converting function.

The signal inputting section 83 of the controlling means 8 is connected to an operation panel 80 and the linear gauge 9 to receive the operation signal and the measured result of the distance h1. Also, the signal outputting section 84 is connected to the holding means 5, the chucking means 3, the coating means 2, the moving means 4, and the linear gauge 9, and output the control signal to these means.

When the chucking means 3 chucks the substrate 10, the controlling means 8 drives/controls the motor of the moving means 4 to move the movable frame 12 (i.e., the substrate 10) from the vacuum chucking position to the coating position side.

Also, the controlling means 8 drives/controls the motor of the lifting portion 22 to lift the liquid tank 25, and also drives/controls the air cylinder of the nozzle lifting section 26 to lift the nozzle 24 with respect to the liquid tank 25.

Also, the controlling means 8 controls the linear gauge 9 and causes the linear gauge 9 to measure the distance h1 to the substrate 10. Then, the controlling means 8 controls the lifting section 22 based on the input measured result to lift the liquid tank 25, so that a clearance between the nozzle 24 and the coated surface of the substrate 10 is controlled.

As shown in FIG. 7, the controlling means 8 stores previously a distance (H) between the nozzle 24 and the vacuum chucking surface of the chucking means 3 and a distance (h0) from the origin position G3 of the linear gauge to the vacuum chucking surface of the chucking means 3 when the liquid tank 25 is positioned at an origin position G1 of the liquid tank and the nozzle 24 is lifted by the nozzle lifting portion 26 and is positioned at an origin position G2 of the nozzle. Also, the controlling means 8 stores an optimum clearance ΔS that permits to prevent the collision of the nozzle 24 against the coated surface and contact the coating liquid to the coated surface without fail when the coating liquid 20 in the nozzle 24 is brought into contact with the substrate 10.

Then, when the controlling means 8 receives the distance h1 from the origin position G3 of the linear gauge to the coated surface of the substrate 10 measured by the linear gauge 9, such controlling means 8 calculates a plate thickness (=h0−h1) of the substrate 10 and also calculates an ascending amount (=H−(h0−h1)−ΔS) of the liquid tank 25 based on calculated plate thickness data to bring the coating liquid into contact with the substrate. Also, in order to form the coating liquid 20 with a film thickness T being input previously after the coating liquid contacts the substrate, the controlling means 8 calculates a descending amount (=T−ΔS) of the liquid tank 25 to bring the coating liquid into contact with the substrate.

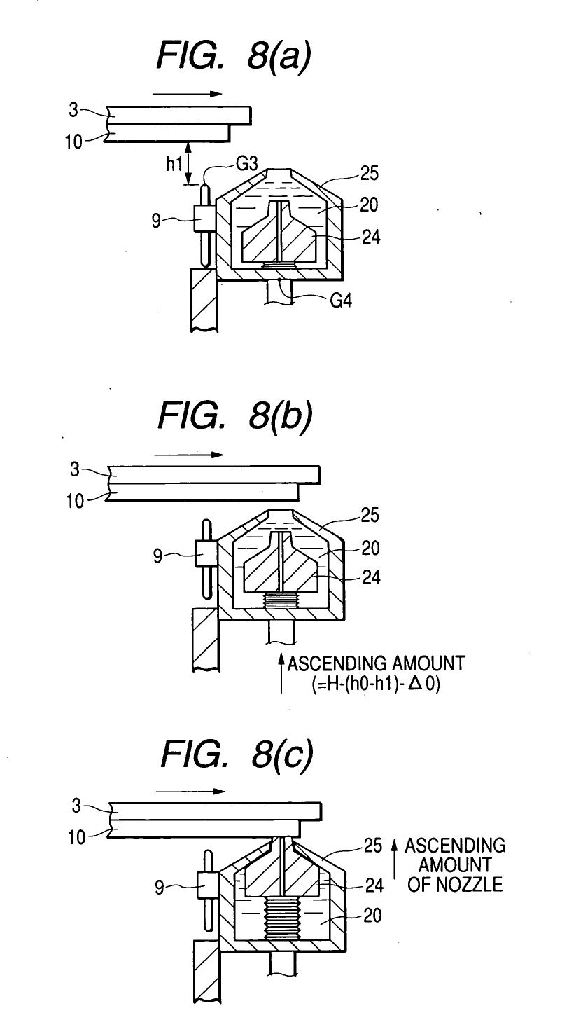

Then, an operation of the coating apparatus 1 constructed as above will be explained with reference to FIG. 8 hereunder.

FIG. 8 shows a schematic view explaining operations of the coating apparatus.

In FIG. 8(a), when the substrate 10 is chucked by the chucking means 3 of the coating apparatus 1, the moving means 4 moves the substrate 10 to the coating position side until an end portion of the substrate 10 on the coating position side is positioned on the linear gauge 9.

Also, the lifting portion 22 of the coating means 2 lifts the supporting plate 21 and sets the liquid tank 25 to the origin position G1 of the liquid tank.

Then, the linear gauge 9 when received the measuring start signal from the controlling means 8 lifts the measuring contact 91 to contact the substrate, then measures the distance (h1) from the origin position G3 of the linear gauge to the coated surface of the substrate 10, then outputs the measured result (contact position data) to the controlling means 8, and then drops the measuring contact 91.

When the controlling means 8 receives the contact position data, such controlling means 8 calculates a plate thickness (h0−h1) of the substrate 10 by subtracting the contact position data (h1) from the distance (h0) from the origin position G3 of the linear gauge to the vacuum chucking surface of the chucking means 3, which is input previously. Then, the controlling means 8 calculates an ascending amount (=H−(h0−h1)−ΔS) of the liquid tank 25 to bring the coating liquid into contact with the substrate.

Then, as shown in FIG. 8(b), the moving means 4 moves the substrate 10 until a coating start position of the substrate 10 is positioned just above the nozzle 24. Then, the lifting portion 22 lifts the liquid tank 25 only by the ascending amount (=H−(h0−h1)−ΔS) calculated by the controlling means 8.

Then, as shown in FIG. 8(c), when the nozzle lifting portion 26 lifts the nozzle 24 only by a predetermined ascending amount Hc, the distance from the nozzle 24 to the coated surface of the substrate 10 becomes ΔS. Thus, the coating liquid 20 that rises due to the capillary phenomenon of the nozzle 24 comes into contact with the coated surface of the substrate 10.

Then, the lifting portion 22 descends the nozzle 24 together with the liquid tank 25 by the descending amount (=T−ΔS) in response to a film thickness T of the coated film to be formed, and then the moving means 4 moves the substrate 10 in the horizontal direction. Thus, the coating film having a uniform film thickness T can be formed on the coated surface (see FIG. 7).

In this manner, according to the coating apparatus 1 of the present embodiment, the distance h1 from the origin position G3 of the linear gauge to the coated surface of the substrate 10 is measured automatically, and then the liquid tank 25 is lifted based on the measured result. Therefore, when the nozzle 24 is lifted by the nozzle lifting portion 26 only by the predetermined amount Hc from the liquid tank 25 that is lifted by the ascending amount (=H−(h0−h1)−ΔS), the coating liquid 20 on the nozzle 24 can be brought preferably into contact with the coated surface. That is, such disadvantages can be avoided that the nozzle 24 touches the substrate 10, the coating liquid is not brought into contact with the substrate or is brought merely partially into contact with the substrate, and so forth.

Also, the distance h1 to the coated surface is measured every substrate 10, and then a clearance between the nozzle 24 and the coated surface can be adjusted based on the measured result. Therefore, even when a plate thickness of the substrate 10 is varied, the coating film having a desired film thickness T can be formed.

In addition, in the coating apparatus 1, the linear gauge 9 is fitted to the liquid tank 25 and thus a distance between the liquid tank 25 and the substrate 10 can be measured directly. Therefore, the clearance between the nozzle 24 and the coated surface can be adjusted with good precision.

Further, when the photo mask blank is used as the substrate 10 and the resist is used as the coating film, the coating apparatus 1 can mass-produce the substrate 10 of high quality effectively.

The holding means 5 has four holding members 55 for holding the peripheral portions of the substrate 10 at four corners. Each holding member 55 of these holding members 55 is fixed to a holding plate 61.

Here, preferably the pushing means, although not shown, should be provided such that the substrate 10 being set onto the holding members 55 is not slipped off from the holding members 55. In this pushing means, for example, a pushing plate is moved vertically and is swung in the horizontal direction. Accordingly, the substrate 10 being set to the holding members 55 that are inclined obliquely is pushed against the holding members 55.

Two holding plates 61 are arranged to rails 63, which are arranged in parallel to oppose to each other in the Y direction, via linear ways 62 respectively. Two holding plates 61 on the back side can be moved by a driving means (not shown) using a ball screw and a motor in the Y direction. As a result, when a longitudinal dimension of the substrate 10 is different, the holding plates 61 are moved by the driving means in the Y direction to face easily to the substrate 10 having a different longitudinal dimension.

Also, both end portions of the rails 63 are fitted to a turning plate 65 via linear ways 64 which are arranged in parallel to oppose to each other in the X direction. The rails 63 can be moved by the driving means (not shown) using the ball screw and the motor in the X direction. As a result, when a lateral dimension of the substrate 10 is different, the holding plates 61 are moved by the driving means in the X direction to face easily to the substrate 10 having a different lateral dimension.

An end portion of the turning plate 65 on the front side is coupled rotatably to a base plate 69 via a rotation axis 66. An end portion on the back side is supported horizontally by a stopper 68 projected from the base plate 69.

Also, the turning plate 65 is turned by a turning cylinder 67 by a predetermined angle. A top end of a rod of the turning cylinder 67 is coupled rotatably to the turning plate 65, and an end portion of a cylinder main body is coupled rotatably to the base plate 69.

Guiding rods 71 provided to pass through a holding means frame 70 are projected from four corners of a lower surface of the base plate 69. The base plate 69 can be moved in the vertical direction by a lifting means 73 such as an air cylinder, or the like provided to a bottom frame 72.

Next, an operation of the coating apparatus la constructed as above will be explained with reference to FIG. 3 hereunder.

First, the coating apparatus la is in its initial state in which the base plate 69 is not lifted by the lifting means 73, the turning plate 65 is supported horizontally, the movable frame 12 is positioned at a process end position, and the coating means 2 is not lifted yet.

In this case, positions of the holding members 55 are adjusted in advance to fit to a longitudinal dimension and a lateral dimension of the substrate 10. In this adjusting, if the rails 63 are moved in the X direction, positioning of the holding members 55 can be easily carried out in answer to the lateral dimension of the substrate 10. Also, if two holding plates 61 on the back side are moved in the Y direction, positioning of the holding members 55 can be easily carried out in answer to the longitudinal dimension of the substrate 10.

Then, the coating apparatus 1a is moved to the set position while swinging the turning plate 65 by virtue of the turning cylinder 67 to rise toward this side.

Then, when the operator who works on the front side of the coating apparatus 1a sets the substrate 10 onto the holding members 55 to direct the coated surface to the coating apparatus 1a side, the pushing means pushes the substrate 10 against the holding members 55. As a result, the coating apparatus 1a can prevent the disadvantage such that the substrate 10 being set to the holding members 55 that are inclined obliquely is slipped off from the holding members 55 and dropped down.

Then, the turning plate 65 is swung by the turning cylinder 67 to fall toward the back side. Then, an end portion of the turning plate 65 on the back side comes into contact with the stopper 68 and the turning plate 65 is supported horizontally.

Then, when the substrate 10 is supported horizontally, the pushing means release the pushing action applied to the substrate 10. In this case, the pushing means is held lower than an upper surface of the substrate 10 after such pushing means release the pushing action. Therefore, even when the substrate 10 is lifted up, the pushing means never comes into contact with the chucking means 3.

Then, the movable frame 12 is moved by the moving means 4 from the process end position to the mount position such that the vacuum chucking position of the chucking means 3 is positioned over the substrate 10. At this time, the coating means 2 is in its sunk state.

Then, the lifting means 73 lifts the base plate 69 until an upper surface of the substrate 10 contacts the chucking means 3. Here, alternately the lifting means 73 may be controlled in such a way that the ascent of the base plate 69 is stopped to leave a minute clearance before the upper surface of the substrate 10 contacts the chucking means 3.

Then, when the chucking means 3 chucks an air via vacuum chucking holes (not shown), the substrate 10 is chucked by the chucking means 3 and then the lifting means 73 is lowered.

Then, the movable frame 12 is moved to the process position side and also the coating means 2 is lifted to a predetermined position to coat the coating liquid on the coated surface of the substrate 10. At this time, the coating means 2 brings the coating liquid that goes up to the top end of the nozzle by the capillary phenomenon into contact with the coated surface, then the nozzle position is adjusted to get a desired coating thickness, and then the movable frame 12 is passed through the process position with keeping this clearance in the vertical direction. Thus, the coating film having a uniform film thickness can be formed on the substrate 10.

Then, when the movable frame 12 is moved to the process end position, the coating means 2 is lowered and then the movable frame 12 is moved to the mount position in the horizontal direction.

Then, the lifting means 73 causes the base plate 69 to rise until the holding members 55 come into contact with the substrate 10. When the holding members 55 come into contact with the substrate 10, the chucking means 3 stops the chucking action to release the substrate by the air blow and then the substrate 10 is loaded on the holding members 55.

In this case, in the situation that the electric charges are accumulated on the substrate 10, if the holding members 55 are made of the insulating material, it is possible to cause the electrostatic breakdown at contact portions between the substrate 10 and the holding members 55 when the substrate 10 is loaded on the holding members 55. In order to prevent such electrostatic breakdown, it is preferable that conductive material such as a metal, or the like should be used as the holding members 55.

Then, the lifting means 73 brings down the base plate 69 and stops, then the pushing means push the substrate 10 against the holding members 55, and then the turning plate 65 is turned to the front side.

Then, when the turning plate 65 is stopped to turn, the pushing means are removed. Thus, the operator can remove readily the substrate 10 on which the coating film is formed from the holding members 55.

In this manner, according to the coating apparatus la of the present embodiment, even though the coating liquid is coated from the lower side in a state that the coated surface of the substrate 10 is directed downward, the positional precision between the substrate 10 and the nozzle of the coating means 2 in the vertical direction can be enhanced since the inverting means that generates the error in the vertical direction is not provided to the moving means 4. Therefore, the coating film having a uniform film thickness can be formed on the substrate 10.

Also, the holding means 5a are turned and set into their inclined state when the substrate 10 is to be set. Therefore, the operator is not required to invert the substrate 10 by 180 degree, and the operator can easily set and remove the substrate 10 on and from the holding members 55 by an inclined angle.

In addition, the holding means 5a has the rails 63 that are fitted movably to the turning plate 65 via the linear ways 64, the holding plates 61 that are fitted movably to the rails 63 via the linear ways 62, and the holding members 55 fitted to the holding plates 61 respectively. Therefore, positions of the holding members 55 can be modified quickly and readily with respect to the substrate 10 having a different size, and thus productivity in change of the apparatus type can be improved.

[Coating Method]

Also, the present invention is effective as a coating method. A coating method of the present invention causes the foregoing coating apparatus la to execute respective processes.

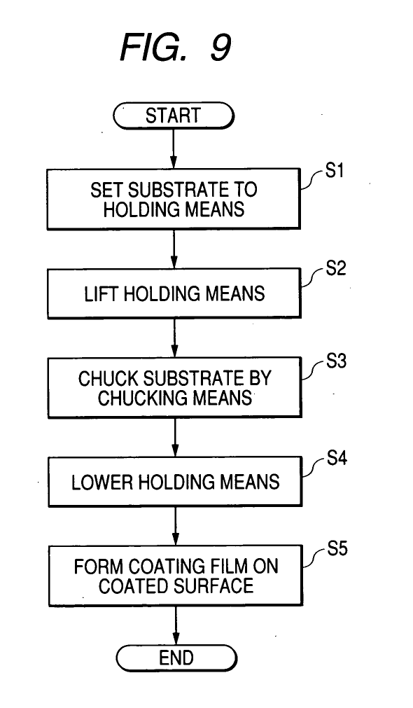

FIG. 9 is a schematic flowchart of the coating method according to the present invention.

In FIG. 9, in this coating method, first the substrate 10 is set to the holding means 5a, i.e., the holding members 55 that are inclined obliquely such that the coated surface of the substrate 10 is directed downward (step S1). Then, the holding members 55 that load the substrate 10 thereon are turned into their horizontal state.

Then, the chucking means 3 is moved over the holding members 55 and positioned. Here, the base plate 69 of the holding means 5a is lifted toward the chucking means 3 that chucks the substrate 10 in a state that the coated surface of the substrate 10 is directed downward, and thus the substrate 10 comes into contact with or comes close to the chucking means 3 (step S2).

Then, the chucking means 3 chucks the substrate 10 (step S3). Then, the base plate 69 of the holding means is lowered (step S4).

Then, a position of the nozzle of the coating means 2 with respect to the substrate 10 (a clearance between the substrate processing means 2 and the substrate 10) in the vertical direction is adjusted, and then the movable frame 12 is moved in the horizontal plane. Thus, the coating film is formed on the coated surface of the substrate 10 (step S5).

In this case, the substrate 10 on which the coating film is formed can be taken away from the above coating apparatus 1a in operational procedures reverse to above procedures.

In this way, according to the coating method of the present invention, there is no necessity to invert the substrate even when the coating film is formed on the coated surface in a state that the coated surface of the substrate 10 is directed downward. Therefore, the coating operation can be simplified, the positional precision between the chucking means 3 and the nozzle can be improved, and the film thickness of the coating film can be uniformized much more.

As the substrate employed preferably in the substrate processing system, the coating apparatus, and the coating method of the present invention, the semiconductor device substrate, the liquid crystal display device or imaging device substrate, or the photo mask blank as the material of the photo mask used to manufacture them are listed. As the most preferable mode, there is a large-sized substrate having each side of 300 mm or more, in which the uniform coating film is needed over a large area, for example, the liquid crystal display device substrate, the photo mask blank as the material of the photo mask used to manufacture it, or the like.

For example, as the photo mask blank, a thin film used to form patterns such as a light shielding film made of chromium-based material, etc. is formed on a transparent substrate made of a quartz glass, or the like. The patterns are formed by forming the resist film on this thin film, then forming resist patterns on the resist film by virtue of the pattern exposure and development, and then etching the thin film using the resist patterns as a mask. As a size of the large-sized photo mask for the liquid crystal out of the photo masks, there are 330×450×5 mm, 390×610×6 mm, 500×570×8 mm, 520×800×10 mm, or more, for example. The present invention can be applied to these substrates having different sizes and different thicknesses. Also, the resist coating is applied preferably as the substrate processing.

As above, the substrate processing system, the coating apparatus, and the coating method of the present invention are explained with reference to the preferable embodiments. But the substrate processing system, the coating apparatus, and the coating method according to the present invention are not limited only to the foregoing embodiments. It is needless to say that various variations and implementations can be applied within a scope of the present invention.

For instance, the holding members 55 are constructed to hold only the outer peripheral portion of the substrate 10. But they are not limited to this configuration. For example, the holding members may hold any portions except the outer peripheral portion unless such portions have an adverse influence on the substrate 10.

Also, a shock absorbing means such as a shock absorber, or the like may be provided not to present a shock to the substrate 10 when the holding members 55 on which the substrate 10 is loaded are brought into contact with the chucking means 3. When doing this, such a disadvantage can be avoided that the substrate 10 is damaged when the substrate 10 is brought into contact with the chucking means 3.

What is claimed is:

1. A substrate processing system comprising:
a holding means for holding detachably a substrate;
a chucking means for chucking the substrate from the holding means in a state that a processes surface of the substrate is directed downward;
a processing means provided under the substrate, for processing the processes surface of the substrate; and
a moving means for moving the processing means and/or the chucking means in a horizontal plane.

2. A coating apparatus for forming a coating film on a coated surface by raising a coating liquid that is reserved below a substrate by a capillary phenomenon of a nozzle, bringing the raised coating liquid into contact with the coated surface of the substrate that is directed downward, and/or then moving the nozzle and the substrate, comprising:
a holding means for holding detachably the substrate;
a chucking means for chucking the substrate from the holding means in a state that the processes surface of the substrate is directed downward; and
a moving means for moving relatively the nozzle and/or the chucking means in a horizontal plane.

3. A coating apparatus according to claim 1 or 2, wherein the holding means levers up the substrate to the vertical direction upon attaching and detaching the substrate by turning the substrate by a predetermined angle.

4. A coating apparatus according to claim 1 or 2, wherein the coating film is made of resist.

5. A coating apparatus according to claims 1 or 2, wherein the substrate is a photo mask blank.

6. A coating method of forming a coating film on a coated surface by raising a coating liquid by a capillary phenomenon of a nozzle, bringing the raised coating liquid into contact with the coated surface of the substrate that is directed downward, and then moving relatively the nozzle and the substrate, comprising steps of:
a step of setting the substrate on a holding means such that the processes surface of the substrate is directed downward;
a step of moving relatively vertically the holding means and/or a chucking means to come close to each other in a state that the processes surface of the substrate is directed downward;
a step of chucking the substrate by the chucking means;
a step of moving relatively vertically the holding means and/or the chucking means to separate from each other; and
a step of forming the coating film on the coated surface of the substrate by moving relatively the nozzle and/or the chucking means in a horizontal plane.

7. A coating method according to claim 6, wherein the coating film is made of resist.

8. A coating method according to claim 6 or 7, wherein the substrate is a photo mask blank.
